(19) United States
(12) Patent Application Publication
(10) Pub. No.: US 2004/0134922 A1
(43) Pub. Date: Jul. 15, 2004

(54) Baking pan with flip down wall panels and method

(76) Inventors: Brooke A. Camhi, Forrest Hills, NY (US); Jason Serapiglia, Staten Island, NY (US)

Correspondence Address: Murray Schaffer, Jaspan Schlesinger Hoffman LLP, 300 Garden City Plaza, Garden City, NY, 11530, US

(21) Appl. No.: 10/340,134

(22) Filed: Jan. 9, 2003

(51) Int. Cl. A23P 1/00

(52) U.S. Cl. 220/912; 99/426

(57) ABSTRACT

A baking container comprising a bottom having a generally vertical peripheral wall. The generally vertical peripheral wall is provided with a plurality of vertical indentations which demarcate a plurality of panels. After the goods are baked, the panels can be separated by applying pressure on the panels alongside the vertical indentations forcing them to separate and split along the vertical indentations and allowing them to be bent outwardly away from the baked goods. This allows easy access to the baked goods via a spatula or other serving means, which easy access in turn facilitates the lifting and removal of the very first individual slices or wedges of the container's baked contents without marring the integrity or appearance of the removed slices or wedges or the baked content remaining in the baking pan.

### BACKGROUND OF THE INVENTION

1. Field of the Invention

The present invention relates to baking containers, including pie pans, baking dishes, baking and serving plates or baking liners. Even more particularly, the present invention relates to a baking container whose generally vertical walls comprise a plurality of vertical indentations which define panels capable of being separated and bent down to facilitate the easy access to, lifting, and removal of individual slices or wedges from the baking container without affecting the integrity or appearance of the slices or wedges being removed from or remaining behind in the baking container.

2. Related and Prior Art Statement

Whether out at a fancy restaurant or at holiday party at home, for most people dessert is the best part of the meal. From apple to lemon meringue pie, to the Greek desserts of baklava and galaktoboureko, few sights stimulate all the senses, as well as the salivary glands, more than a freshly baked, well-formed, tastefully-decorated, and beautifully-arranged piece of confectionary delight. However, to those who have had the patience and inspiration to bake such treats, nothing is more disappointing than the messy removal of the first piece and the resulting damage to the appearance of the remaining dessert, due to the baker's inability to remove the first piece quickly, smoothly, and evenly.

For example, anyone who has tried to serve pie can personally attest to the difficulty of removing the first piece from the pie pan. Usually it involves cutting the pie into six, eight or twelve wedges, and then attempting to carefully slide an appropriately sized spatula down the angled wall of the pie pan. Thereafter, maneuvering the spatula so that its triangular tip slides right under the pie piece towards the center of the pie, the pie piece is carefully lifted up and away in a manner that leaves the removed piece unblenushed and the neighboring pieces completely unscathed. Instead, nine times out of ten the result of this effort is a disheartening, mangled mess of pie that looks far from appetizing and is an embarrassment to the server. Inevitably this leads to wasting good pie, as baker and consumer are often left with no choice but to discard the damaged piece and perhaps parts of any neighboring pieces which too have been deformed.

Baking pan inventions abound. For example U.S. Pat. No. 6,258,3920 for a Microwavable Pasta Pie And Pan Assembly allows for cooking methods utilizing a microwave. U.S. Pat. No. 3,987,720 for a No Drip Pie Plate addresses the danger of pie juices dripping off the plate during baking. U.S. Pat. No. 5,924,591 for an Annular Pizza Pan With Solid Bottom is directed to preventing the undercooking of a pizza center. U.S. Pat. No. 4,228,731 for a Pie Crust Shaper is directed to preventing pie crust distortions during baking. U.S. Pat. No. 5,806,411 for a Pastry Shield And Cooling Stand discloses and claims a method for the prevention of overcooking and burning and for assisting in proper cooling. U.S. Pat. No. 5,456,162 for a Pie Crust Baking Shield is directed to solving the burning or charring of the outer edge of a pie crust during baking. U.S. Pat. No. 5,074,777 for an Apparatus For Making A Split Pie is directed to the pie's contents. As for U.S. Pat. No. D 457,777 (“Pie Plate”); U.S. Pat. No. D 436,494 S; U.S. Pat. No. Des. 367,398 (“Pie Plate”); U.S. Pat. No. 5,453,287 (“Method For Preparing Food Products Using Interconnectable Panels”); U.S. Pat. No. Des. 293,995 (“Pie Dish”); and U.S. Pat. No. 4,452,419 (“Modular Cake Pan”), they all deal with the baked goods' exterior, allowing the baker to give a particular look, shape or ornamentation to the pie. Finally, food containers, such as that exemplified in U.S. Pat. No. 5,860,549, Container For Stabilizing A Food Dish, are specifically designed to stabilize the pie during shipping and storage, thus insuring that the appearance and quality of the food contents remain undamaged.

However, none of the patents set forth above have been designed, and nor do they suggest that they can be used for the easy removal of unscathed pie slices or wedges or baked goods pieces, while simultaneously preserving the appearance of the remaining contents of the baking containers. Even more importantly though, inherent in all of these patents is the fact that their design must comprise a surrounding solid peripheral wall which not only does not allow easy access to the pie slice or wedge bottom by way of horizontal motion of the spatula, but which actually teaches away from the solution of the present invention, i.e. the easy removal of baked goods' pieces, while simultaneously preserving the appearance of the removed and remaining contents of the baking containers.

### OBJECTS OF THE INVENTION

Accordingly, it is an object of the present invention to provide a means for access to and the removal of first and subsequent slices or wedges of baked goods, and more particularly means for the removal of individual baked goods' slices or wedges from a baking container in such a manner that does not destroy the integrity of the first individual baked goods' piece removed.

It is another object of the present invention to provide a means for access to and the removal of first and subsequent slices or wedges of baked goods, and more particularly means for the removal of individual baked goods' slices or wedges from a baking container in such a manner that does not detract from the appearance of the first individual baked goods' slices removed.

It is a further object of the present invention to provide a means for access to and the removal of first and subsequent slices or wedges of baked goods, and more particularly means for the removal of individual baked goods' slices or wedges from a baking container in such a manner that does not destroy or deform surrounding baked goods' pieces.

It is still another object of the present invention to provide a means for access to and the removal of first and subsequent slices or wedges of baked goods, and more particularly means for the removal of individual baked goods' slices or wedges from a baking container in such a manner that is quick and easy.

These and other objects will become readily apparent from the detailed description of the invention and the drawings that follow below.

### SUMMARY OF THE INVENTION

According to the present invention and method there is provided a baking container comprising a bottom having a generally vertical peripheral wall. The generally vertical peripheral wall is provided with a plurality of vertical indentations which demarcate and define a plurality of panels. After the goods are baked, the panels can be separated by applying opposing force on the panels alongside the vertical indentations causing the panels to separate and split along the vertical indentations to allow the panels to be bent outwardly away from the baked goods. This allows easy access to the baked goods via a spatula or other serving means, which easy access in turn facilitates the lifting and removal of the very first individual slices or wedges of the container's baked contents without marring the integrity or appearance of the removed slices or wedges or the baked goods remaining behind in the baking pan. Once the desired slice or wedge is removed, the wall panel may be repositioned.

### BRIEF DESCRIPTION OF THE DRAWINGS

While the specification concludes with claims which particularly point out and distinctly claim the present invention, it is believed that the present invention will be better understood from the following detailed description taken in conjunction with the accompanying drawings in which like numerals represent identical elements and wherein:

FIG. 1 is an upper perspective view of one embodiment of the inventive baking container made and used in accordance with the present invention;

FIG. 2 is a top view thereof;

FIG. 3 is a bottom view thereof;

FIG. 4 is a side view thereof;

FIG. 5 is a top view of an alternate embodiment of FIGS. 1-4;

FIG. 6 is a top view of an alternate embodiment of FIGS. 1-5;

FIG. 7 is a top view of an alternate embodiment of FIGS. 1-6;

FIG. 8 is a top view of an alternate embodiment of FIGS. 1-7;

FIG. 9 is a top view of an alternate embodiment of FIGS. 1-8;

FIG. 10 is a top view of an alternate embodiment of FIGS. 1-9 in the form of a pan liner.

### LIST OF ELEMENTS AND THEIR RESPECTIVE IDENTIFYING NUMERALS

| NO | ELEMENT |
|---|---|
| 10 | Baking container or pan |
| 11 | Bottom |
| 12 | Generally vertical peripheral wall |
| 16 | Panel(s) |
| 18 | Weakened or thinner area(s); vertical |
| | indentation(s) |
| 20 | Top edge of panel(s) |
| 22 | Bottom edge of panel(s) |

### DETAILED DESCRIPTION OF THE INVENTION

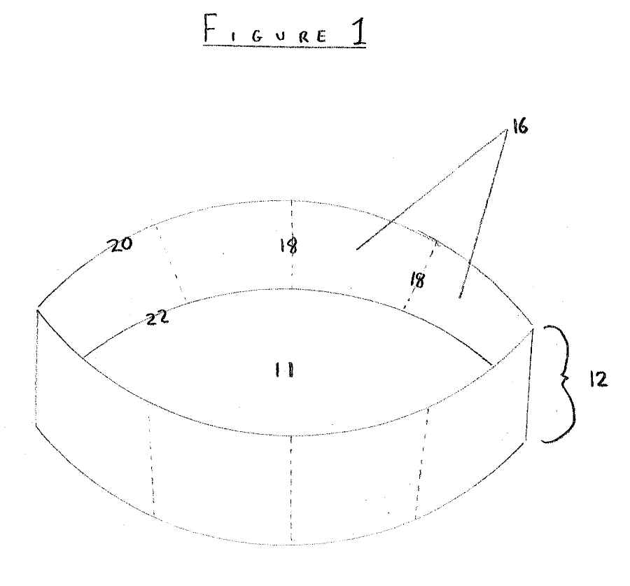

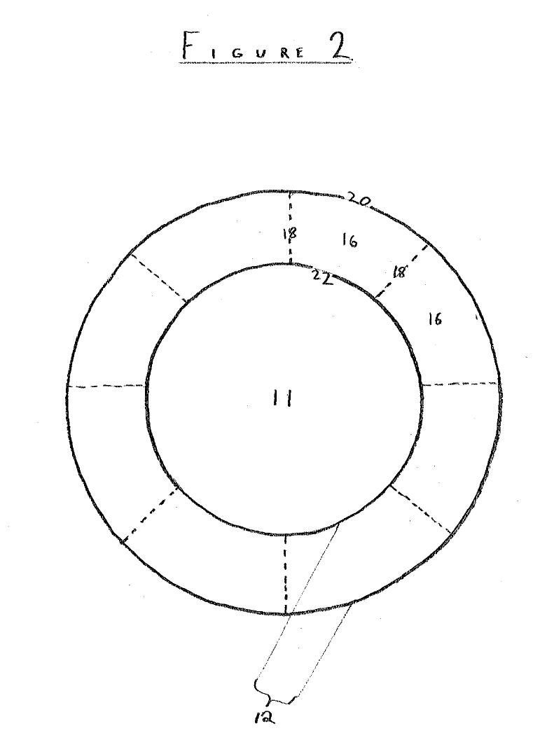

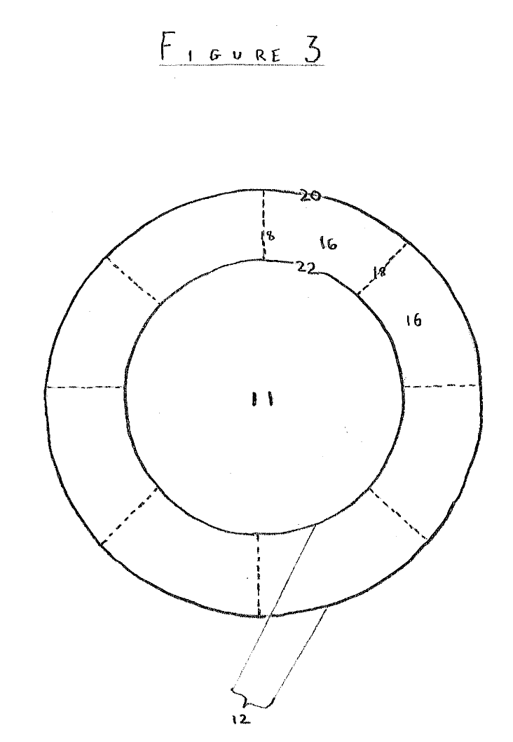

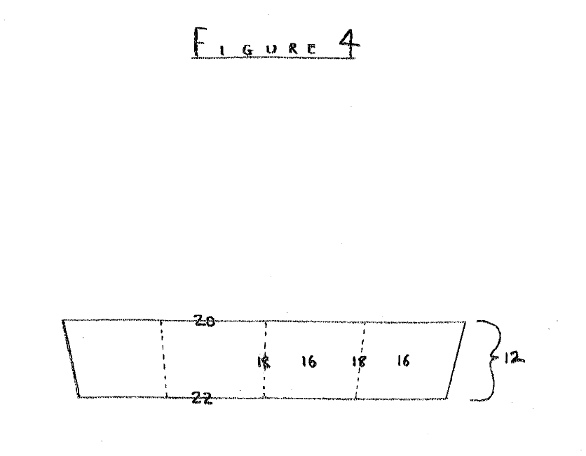

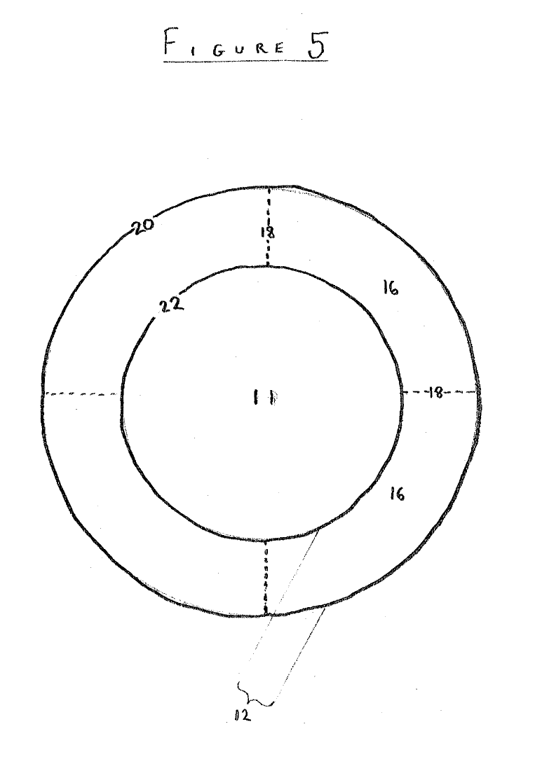

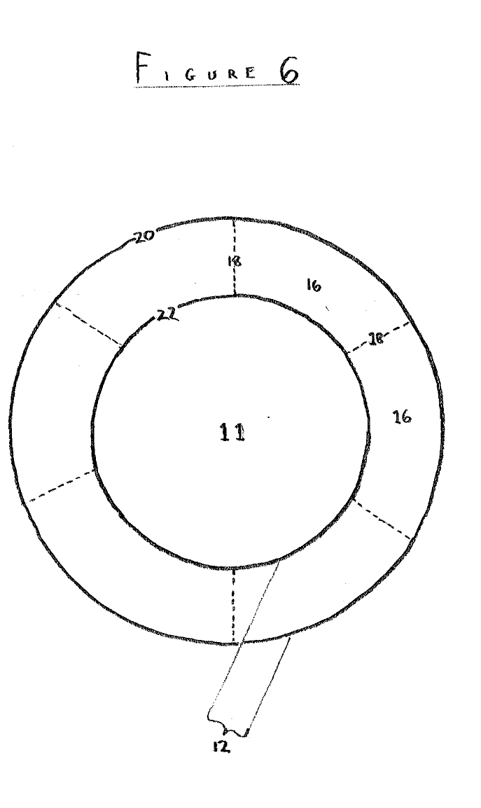

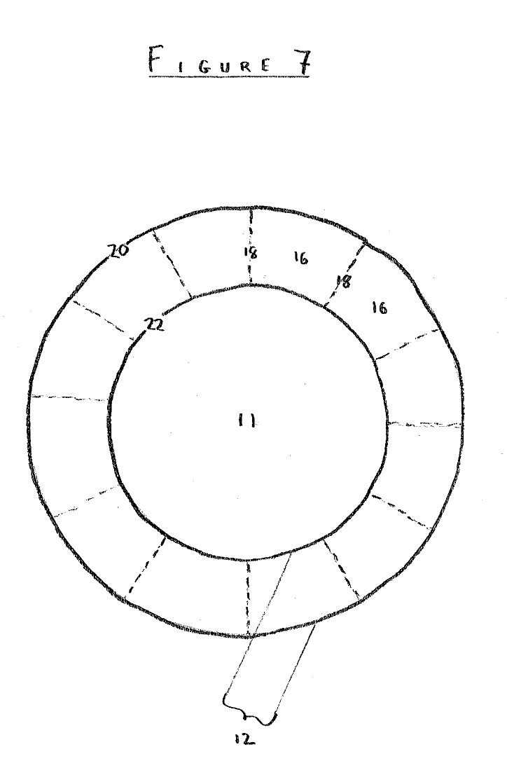

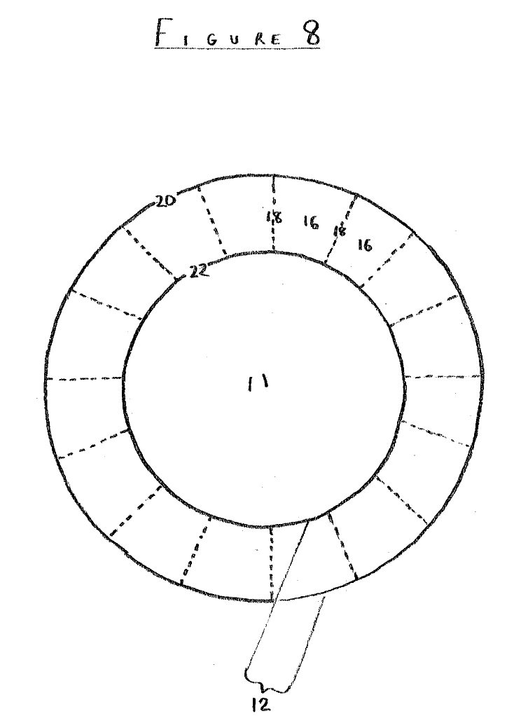

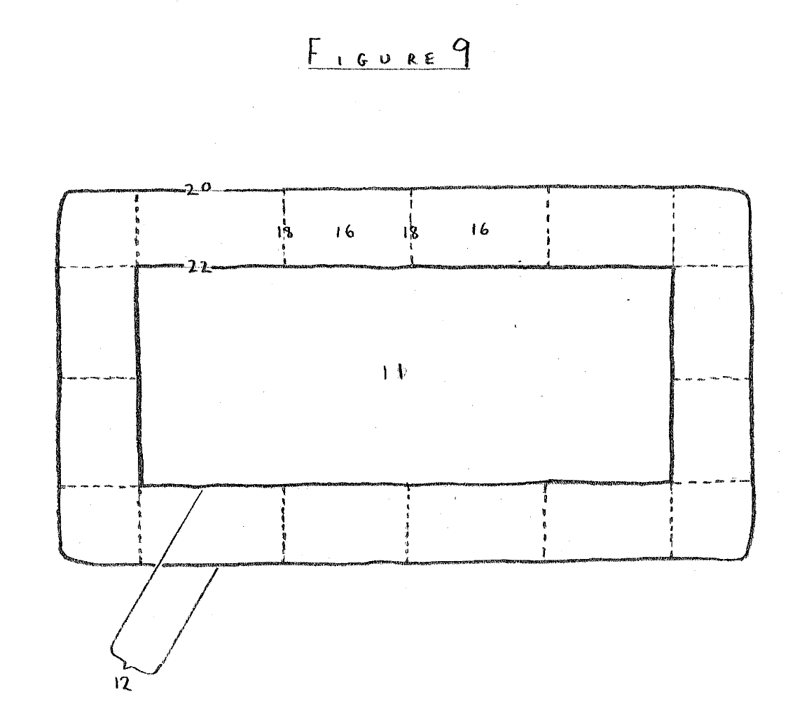

Turning to FIGS. 1-9, the inventive baking container or pan generally depicted as 10, can be used to cook, bake, cook, heat, cool, serve, store or display any type of bakable goods, including pies. It comprises a bottom 11, and a generally vertical peripheral wall 12. The generally vertical peripheral wall 12 stands up and above the bottom 11 to contain and support the contents of the baking pan 10 as they are cooked in the oven or cooled, served or stored. While the baking pan 10 has been depicted in mostly round embodiment, it is readily apparent to one skilled in the art that it can also be square, rectangular, oval, or even polygonal, as exemplified in the alternate embodiment in FIG. 9.

As set forth above, the generally vertical peripheral wall 12 forms a solid continuous boundary which together with the bottom 11 retains the bakable goods within the baking pan 10. It has a bottom edge 22 and a top edge 20. It can be angled away from the bottom 11, as for example in a pie pan, or can be perpendicular to the bottom 11, as for example in a lasagna pan. Further, the generally vertical peripheral wall 12 is provided with multiple transverse vertical indentations 18, which extend from the bottom edge 22 to the top edge 20 of the generally vertical peripheral wall 12. These vertical indentations 18 can be grooves, notches, recessed lines, and/or non-permeable perforations which along their entire transverse length reduce the thickness of and weaken the generally vertical peripheral wall 12. Furthermore they help to demarcate and define wall panels 16. These wall panels 16 can be easily separated, flipped open, and bent down by hand to allow easy access to the baking pan's 10 contents for their easy and nondestructive removal and then repositioned when removal is done.

It is imperative that to avoid leaking of the baking pan's contents during baking and subsequent cooling or storage, the vertical indentations 18 do not fully cut or bore through the generally vertical peripheral wall structure 12. Instead, as set forth above, they are made to form weakened or thinner latitudinal areas 18 of the pan material which are susceptible to separation, tearing, or cutting. Upon the application of force in opposing directions along either side of such weakened or thinner areas 18, adjacent panels 16 are separated along such weakened or thinner areas 18. Thereafter the separated panels 16, still attached to the bottom 11, may be bent or flipped outwardly and away from the baked goods while still connected to the bottom 11, to reveal the peripheral side of the baking pan's 10 contents and create an opening by which slices or wedges may be easily accessed and removed.

The preferred method for removing a specific slice or wedge from the baking pan 10 comprises the following steps: (i) determining the size and number of slices or wedges that will be cut; (ii) choosing a particular slice or wedge for removal; (iii) identifying each of the vertical indentations 18 and the panel 16 corresponding to the slice or wedge designated for removal; (iv) applying opposing forces on each of the panels 16 adjacent to each of the vertical indentations 18 demarcating the panel 16 corresponding to the selected slice or wedge to be removed, to the top edge 20, sufficient to cause the panel 16, corresponding to the slice to be removed, to separate from the panels immediately adjacent to it, and to become unrestrained on three sides; (v) applying a force to the top edge 20 of the unrestrained panel 16 in an outwardly direction away from the baked goods' contents to reveal an opening in the baking pan's 10 continuous, generally vertical peripheral wall 12, whereby the peripheral or outer side of the slice or wedge can be accessed; (vi) using a cutting means to easily and smoothly cut straight down onto either side of the slice or wedge, without interference and without damage being incurred to the baked goods' crust or filling; (vii) maneuvering a spatula or other serving means horizontally, front tip first, under the slice's or wedge's exposed side and the slice's or wedge's underside; (viii) and using the spatula or other serving means with an upward motion such that said slice or wedge is quickly and smoothly lifted up and away from the baking pan's bottom 11 without damage to the slice or wedge or to neighboring pie areas.

The material used for the baking pan 10 will be strong enough to withstand the usual stresses of baking, storage and shipment, but at the same time be capable of being separated by hand along the weakened or thinner areas 18 of the generally vertical peripheral wall 12. The thickness, height, size, shape, and material used for the baking pan 10 will vary with (i) the method of baking, cooking, transport, storage or display intended; (ii) the industry and product involved, which may be non-baked-good or non-food related; and (iii) whether the baking pan 10 is intended to be reusable or disposable.

The number, shape and size of the slices or wedges that can be generated from the baked goods will vary depending on the user's preference. Circular pies, for example, are often cut into four, six, eight, twelve, or sixteen pieces. Accordingly, as shown in FIGS. 1-9, embodiments of the baking pan 10 may differ in the number of panels 16 provided. Further, the user employing any particular embodiment can vary the size and number of slices or wedges cut by simply choosing to separate alternate, or twice, or three times removed weakened or thinner areas 18 thus creating panels 16 of varying sizes.

Some bakers do not cut the slices or wedges into the pie all at once but instead choose to do so on a piece by piece basis. In either case, the user may use the location and spacing of the weakened or thinner areas 18 as a guide in cutting the pie.

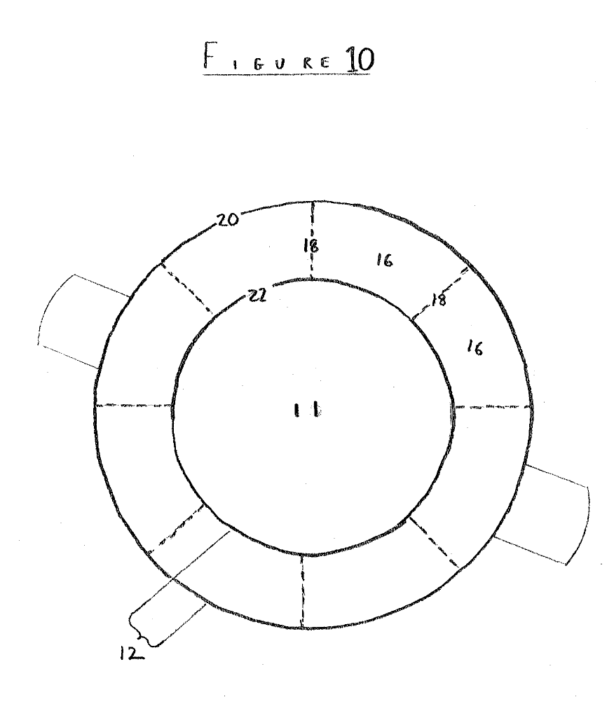

Another embodiment of the inventive baking container 10 is that of a baking pan liner, as in FIG. 10, which can be used to line the internal surface area of any baking container. Like the embodiments above, the liner is provided with all of the inventive characteristics to help remove pieces of baked goods without marring the appearance of either the removed or the remaining baked goods. The liner is provided with tabs which, at the end of the baking process, are used to lift and remove the baked goods from the outside baking container for placement in a dish. Just as above, liner panels 16 may be separated along the vertical indentations 18 to create bendable panels providing easy access to the baked goods contents therein.

The embodiments described above are provided by way of illustration only and should not be construed to limit the invention. Those skilled in the art, both within and without the area of food preparation and serving, will readily recognize various modifications and changes, which may be made to the present invention without strictly following the exemplary embodiments and applications illustrated and described herein and without departing from the true scope of the present invention, which is set forth in the following claims.

What is claimed is:

1. A container useful for baking bakable goods comprising a bottom, a generally vertical peripheral wall having a plurality of vertical indentations demarcating a plurality of panels, said panels being separable along said vertical indentations to facilitate easy access to, lifting and removal of the bakable goods, without affecting the integrity and appearance of the bakable goods.

2. The container according to claim 1, wherein said panels are bendable away from the bakable goods.

3. A container useful for baking bakable goods comprising a generally vertical peripheral wall having a plurality of vertical indentations demarcating a plurality of panels, said panels being separable along said vertical indentations to facilitate easy access to, lifting and removal of the bakable goods, without affecting the integrity and appearance of the bakable goods.

4. The container according to claim 3, wherein said panels are bendable away from the bakable goods.

5. A container useful for baking bakable goods comprising a generally vertical peripheral wall having a plurality of panels, said panels being separable to facilitate easy access to, lifting and removal of the bakable goods, without affecting the integrity and appearance of the bakable goods.

6. The container according to claim 5, wherein said panels are bendable away from the bakable goods.
